(19) United States
(12) Patent Application Publication
(10) Pub. No.: US 2017/0167195 A1
(43) Pub. Date: Jun. 15, 2017

(54) TELESCOPICALLY EXTENDABLE/COLLAPSIBLE LADDER AND METHOD TO FASHION AND USE THE SAME

(71) Applicant: MICHAEL MUTCHNIK HOLDINGS INC., MONTREAL (CA)

(72) Inventor: Michael Mutchnik, Montreal (CA)

(73) Assignee: MICHAEL MUTCHNIK, MONTREAL (CA)

(21) Appl. No.: 14/963,495

(22) Filed: Dec. 9, 2015

(51) Int. Cl. E06C 1/12

(52) U.S. Cl. CPC E06C 1/125

(57) ABSTRACT

A telescopically extendable/collapsible ladder designed to be set into needed extended or collapsed mode, and method to fashion and use the same, set forth by way of example and not limitation, the ladder being composed of several ladder sections, each of the ladder sections being telescopically inserted into a ladder section located below, with a possibility to be extended/collapsed and locked/unlocked into a needed position, and where at least one ladder section is being fashioned with a pass-through portion providing an unobstructed passage through this pass-through portion.

### FIELD

The present invention relates to a ladder, and more specifically to a telescopically extendable/collapsible ladder designed to be set into extendable or collapsed mode as needed.

### BACKGROUND OF THE INVENTION

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

A telescopically extendable/collapsible ladder is well known and is being used widely for different applications by professionals as well as by individuals. The telescopically extendable/collapsible ladder is in usage when at least partially extended, and can be easily transported or stored in a small space in a collapsible mode.

As a prior art illustration, we refer to U.S. Pat. No. 8,104,580 (inventor Per-Olof Eriksson); to U.S. Pat. No. 6,708,800 (inventors Mitchell I. Kieffer et all); to US Application for Patent 2010/0133041 (inventor Kecheng Wang) and to “Operational and care instruction book for your Xtend & climb ladder” published on the website www.getladder.com.

Typically, the extendable/collapsible ladder is formed by several ladder sections telescopically mutually associated. Each ladder section is adjustably protruding from a lower ladder section and is locked to be secured in an extended position or unlocked to be collapsed into a storing mode.

Safety problems with the known in the art telescopically extendable/collapsible ladder are arising significantly when a user needs to go from or onto this ladder during his climbing up or down. To achieve this, the user must step around at least one (most frequently, an uppermost) ladder section. Generally speaking, the user thus has to perform an extremely risky maneuver and jeopardize his balance. That risk is compounded, as the maneuver usually needs to be done on a height. During above mentioned attempts, the possibility of lateral displacement or even fall of the ladder in increasing significantly. In the case of any risky operation, such as rescue, time limited situation, the hazard of using now existing telescopically extendable/collapsible ladder is even more increased.

Our invention consists of a telescopically extendable/collapsible ladder that combines the benefits of the telescopically extendable/collapsible ladder known in the prior art, but without its unsafe negative aspects when the user needs to go from or onto the ladder during his climbing up or down and/or a burden delivering.

Thus, there exists a need to improve a telescopically extendable/collapsible ladder well-known in the prior art to avoid said hazard and to get better user's safety and security during his attempts to go from or onto the extendable/collapsible ladder,

### OBJECTS OF THE INVENTION

It is an object of the present invention to improve at least some of the inconveniences present in the prior art.

It is another object of the present invention to provide a new telescopically extendable/collapsible ladder allowing the user to go safely and unharmed from or onto the ladder during his climbing up or down.

It is an additional object of the present invention to avoid the necessity of risky maneuvers of the user, such as stepping around when the user wants to go from or onto the telescopically extendable/collapsible ladder during his climbing up or down this ladder or during the burden delivery.

It is a next object of the present invention to avoid the necessity of risky maneuvers of the user, such as step over the at least one upper ladder section when the user wants to go from or onto the telescopically extendable/collapsible ladder during his climbing up or down this ladder or during the burden delivery.

It is an extra object of the present invention to create a new telescopically extendable/collapsible ladder having something to hold on to during movements from or onto the extendable/collapsible ladder and permitting the user to self-sustain during this movement.

It is a more object of the present invention to put in more safety and security advantages to telescopically extendable/collapsible ladder applications.

Further objects and advantages of the invention will be in part obvious from an inspection of the accompanying drawings and a careful consideration of the following description.

### BRIEF SUMMARY OF THE INVENTION

To achieve above mentioned objects, the telescopioally extendable/collapsible ladder, described in the present specification of the invention, provides the user with an unobstructed passage through at least one ladder section and allows the user to go safely from or onto the extendable/collapsible ladder during climbing up and down with or without burden.

The telescopically extendable/collapsible ladder is designed to be set into needed extended or collapsed mode. It being composed of a several ladder sections, each of the ladder sections is telescopically inserted into a ladder section located below, and can be locked or unlocked into extended or collapsed mode.

At least one ladder section is fashioned with a pass-through portion to provide the user with a possibility of an unobstructed and safe passage through this at least one ladder section or safely deliver a burden through the same. Although as it is often the uppermost ladder section which is being fashioned with the pass-through portion, any other ladder section or a combination of ladder sections could be fashioned with the pass-through portion.

The pass-through portion could be fashioned as a saw cut dividing the at least one ladder section onto autonomous elements.

As well the pass-through portion of the at least one ladder section could be fashioned by at least one autonomous element, which is telescopically inserted into the ladder section located below, and can be extended/collapsed and looked/unlocked, into needed position. The autonomous element could be fashioned as a part of the ladder section as well.

For the purposes of the present specification, the autonomous element could be telescopic.

At least one associate means user to cooperate with the at least one autonomous element of the at least one ladder section with the possibility to liberate the pass-through portion of the at least one ladder section for an unobstructed and safe user's passage through this section, or to close up (obstructs) this pass-through portion.

The pass-through portion could be liberated by different manners, only some possible examples being shown in the drawings for illustration.

In the context of the present specification of the invention, the associate means could be telescopic.

Alternatively, the pass-through portion of the at least one (often the uppermost) ladder section can be fashioned by two autonomous elements. The autonomous elements are telescopically inserted into another ladder section (typically located below), and each autonomous element can be extended/collapsed and locked/unlocked on an equal or not level. The autonomous elements (both or only one) cold be telescopic.

In the context of the present specification of the invention, the ladder further comprises at least one associate means being joined to at least one of the autonomous elements of the at least one (often the uppermost) ladder section. This allows a possibility of liberating the pass-through portion of the at least one ladder section for an unobstructed and safe passage through this section, or to obstruct this pass-through portion if so desired. The associated means could be telescopic.

The autonomous element(s) could be inserted into another ladder section (typically the one located below) with a possibility to be rotated into the necessary position relative to the ladder surface, and could be locked in this position after the rotation. When an upper part of the autonomous element(s) is angularly oriented to the ladder surface it creates a hooking-effect to secure the telescopically extendable/collapsible ladder in preferable position. The autonomous elements could be equally or not equally angularly oriented to the ladder surface.

This invention also includes a method to fashion and use the telesoopically extendable/collapsible ladder designed to be set into an extended or collapsed mode as needed. The ladder is composed of several ladder sections. Each of the ladder sections are telescopically inserted into a ladder section located below, to form the aforementioned telescopically extendable/collapsible ladder, with a possibility to be extended/collapsed and locked/unlocked in the necessary position.

The method comprises a steps of fashioning at least one ladder section with a pass-through portion; extending the telescopically extendable/collapsible ladder into required mode (needed level), providing an unobstructed and safe passage through the pass-through portion of the at least one ladder section of the telescopically extendable/collapsible ladder.

In the context of the present invention, wherein the at least one ladder section is at least one uppermost ladder section, the method comprises the steps of fashioning the at least one uppermost ladder section with the pass-through portion; at least partially extending the telescopically extendable/collapsible ladder to set it into a required mode; extending the at least one (more often the uppermost) ladder section containing the pass-through portion into a needed level; and providing an unobstructed passage through the pass-through portion of the at least one ladder section of the telescopically extendable/collapsible ladder.

The method, according to present invention, includes a possibility to make the pass-through portion as a cut (it could be, for example, a saw cut or any other type of cut) dividing the at least one ladder section onto autonomous elements, A possibility of an unobstructed and safe passage of the user through at least one (often uppermost) ladder section of this telescopically extendable/collapsible ladder is providing

The pass-through portion of the at least one ladder section could be fashioned by at least one autonomous element being telescopically inserted into a ladder section of the telescopically extendable/coilapsible ladder typically located below, with a possibility to be extended/collapsed and locked/unlocked in needed level. The autonomous element might be telescopic to be arranged in the required mode.

In some embodiments, the method further includes the step of joining at least one associate means to at least one autonomous element of the at least one (could be the uppermost) ladder section for cooperation with a possibility to liberate the pass-through portion of this ladder section for an unobstructed arid safe passage of the user through this section, or to obstruct this pass-through portion while its need to be done. When the associate means is telescopic, the method includes ways to arrange this associate means in the required mode.

The pass-through portion of at least one (could be the uppermost) ladder section could also be fashioned by two autonomous elements. The autonomous elements are telescopically inserted into a lower ladder section, with a possibility to be extended/collapsed and locked/unlocked on equal or not level.

In this embodiment, the method also includes the step of joining at least one associate means to at least one of two autonomous elements of the at least one uppermost ladder section of the telescopically extendable/collapsible ladder for cooperation with the possibility to liberate the pass-through portion of the at least one ladder section for an unobstructed and safe user's passage through this section, or to obstruct this pass-through portion. When the autonomous element or/and the associate means are telescopic, the method includes ways to arrange them in required mode.

The autonomous element could be inserted into another ladder section (typically the one located below) with a possibility to be rotated into the necessary position relative to the ladder surface, and could be locked in the necessary position after the rotation. When an upper part of the autonomous element is angularly oriented to the ladder surface, the method creates a hooking effect to secure the telescopically extendable/collapsible ladder in a preferable position. The autonomous elements could be equally or not equally angularly oriented to the ladder surface.

Embodiments each have at least one of the above-mentioned objects and/or aspects, but do not necessarily have all of them. It should be understood that some aspects of the present invention that have resulted from attempting to attain the above-mentioned objects may not satisfy one of objects and/or may satisfy other objects not specifically recited herein.

Additional and/or alternative features, objects, aspects and advantages of the present invention will become apparent from the following description and the appended claims.

### BRIEF DESCRIPTION OF THE DRAWINGS

For a better understanding of the present invention, as well as other aspects and further features thereof, reference is made to the following description which is to be used in conjunction with the accompanying drawings, where:

FIG. 1 is showing a prior art illustration of a conventional telescopically extendable/collapsible ladder in collapsed mode;

FIG. 1a is showing the prior art of FIG. 1 in extended mode;

FIG. 2 is a front view showing of a telescopically extendable/collapsible ladder being the first embodiment of the present invention;

FIG. 3a is a front view showing the ladder of FIG. 2 in extended mode;

FIG. 3 is a front view showing the telescopically extendable/collapsible ladder being another embodiment of the present invention;

FIG. 3a is a front view showing the ladder of FIG. 3 in extended mode when a part of an uppermost ladder section is extended;

FIG. 4 is a front view showing the telescopically extendable/collapsible ladder being yet another embodiment of the present invention;

FIG. 4a is a front view showing of the ladder of FIG. 4 in extended mode;

FIG. 4b is a front view showing the ladder of FIG. 4 in partially extended mode;

FIG. 5 is a front view showing the telescopically extendable/collapsible ladder being a further embodiment of the present invention;

FIG. 5a is a front view showing of the ladder of FIG. 5 in extended mode;

FIG. 6 is a front view showing the telescopically extendable/collapsible ladder being a yet further embodiment of the present invention;

FIG. 6a is a front view showing of the ladder of FIG. 6 in extended. mode;

FIG. 7 is a front view showing the telescopically extendable/collapsible ladder being one more embodiment of the present invention;

FIG. 7a is a front view showing the ladder of FIG. 7 in extended mode;

FIG. 8 is a front view showing the telescopically extendable/collapsible ladder being a yet more embodiment of the present invention;

FIG. 8a is a front view showing the ladder of FIG. 2 in extended mode;

FIG. 9 is a front view showing the telescopically extendable/collapsible ladder being a related embodiment of the present invention;

FIG. 9a is a front view showing the uppermost part of the ladder of FIG. 9 in one of possible extensions;

FIG. 9b is a front view showing the uppermost part of the ladder of FIG. 9 in another possible extension; and

FIG. 10 is a front view of the telescopically extendable/collapsible ladder being another related embodiment of the present invention.

### DETAILED DESCRIPTION OF THE INVENTION

The description that follows in this section is not an attempt at defining (and is not intended to define, limit or otherwise restrict) the scope of the present device, but simply to provide information related to the present device as an aid in its understanding.

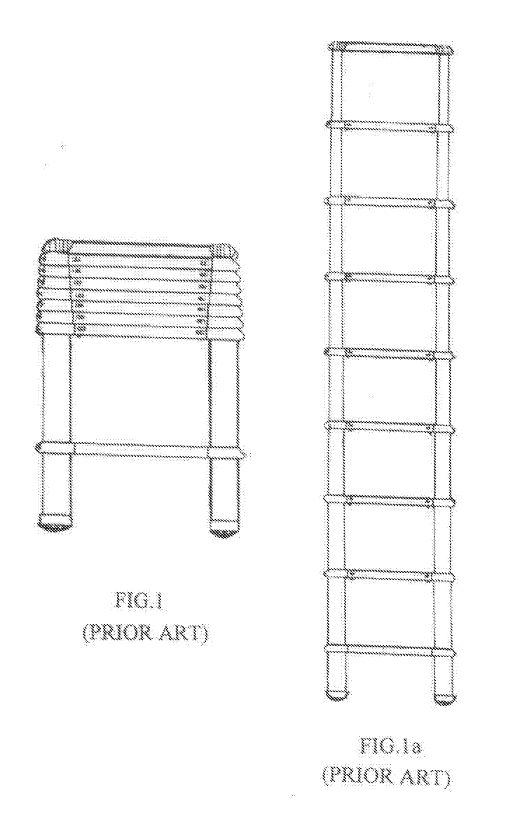

FIGS. 1 and 1are illustrated prior art of the present invention. Referring to FIG. 1, a telescopically extendable/collapsible ladder, conventional and well known in the art, is presented in a collapsed mode, ready to be stored or transported. For a user, this mode is attractive and convenient, but when the ladder is in extended mode (FIG. 1b), its exploitation has very serious safety issues, the most serious of which is the difficulty for the user to go from or onto an upper part of this ladder without obstacles, as well as to deliver a burden, which sometimes is heavy and bulky. When it is necessary to go from or onto the upper part of this ladder, the user needs to step over at least one uppermost ladder section or step around this upper part of the ladder and to take a risk of losing his balance. Generally spiking, to do this, the user has to perform an extremely risky acrobatic maneuver in both of those cases, and this risk is very often compounded by the fact that the maneuver needs to be done on a height. The risk could be worsened further by the likelihood of the ladder's lateral displacement or even fall during the maneuvers.

To get better the safety use of the ladder, as well as to give a broad application and to improve the performance, usability and utilization of the telescopically extendable/collapsible ladder, known in the prior art, a user should not be in dangerous conditions when it is necessary to walk off from or onto this telescopically extendable/collapsible ladder. For this reason, according to our invention, an unobstructed and safe passage through at least one ladder section of this telescopically extendable/collapsible ladder needs to be provided. The pass-through portion should be fashioned through at least one ladder section when the user needs to go from or onto the upper part of the ladder or to deliver a different burden.

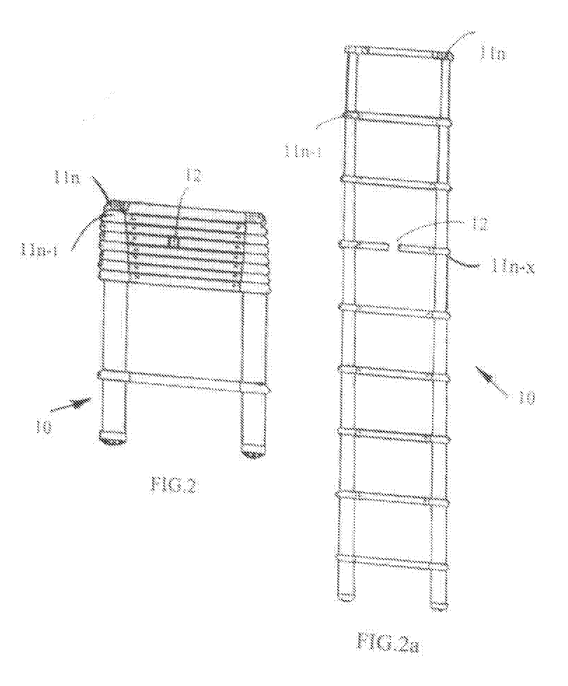

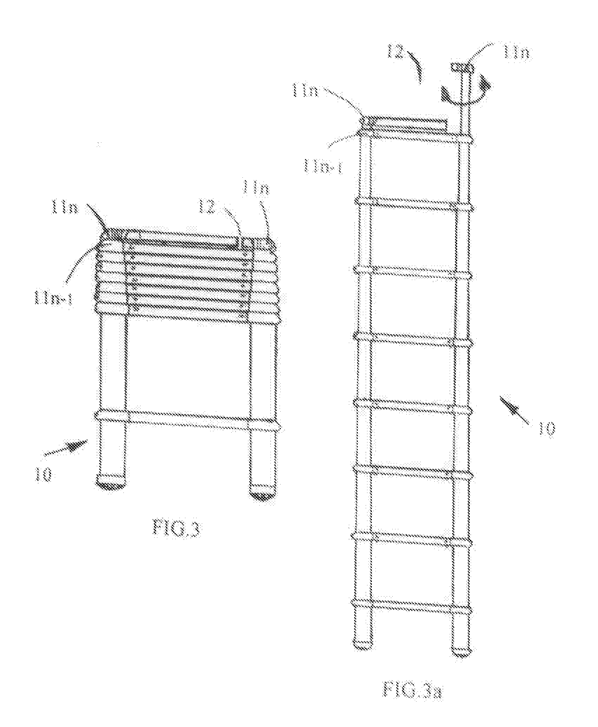

Referring to FIGS. 2 to 10, according to the present invention, the telescopically extendable/collapsible ladder 10 includes a number (n) of ladder section 11, . . . , 11n (lowest to highest). Each ladder section 11, . . . , 11n is telescopically inserted into a ladder section located below (for instance, section 11n is telescopically inserted into section 1 section 11n-1 into section 11n-1, and so on), and can be extended/collapsed and locked/unlocked, to form this telescopically extendable/collapsible ladder 10. At least one ladder section (for example, in FIG. 2a, it is ladder section 11n-x, on FIG. 3a, it is ladder section 11n) is fashioned with a pass-through portion 12 to provide an unobstructed passage through this portion.

Below (see FIG. 3 to 10) is more precise description of the different embodiments of the present invention related to at least one (often the uppermost) ladder section, but it is obvious for those of ordinary skill in the art that the pass-through portion 12 could be made on any one or more of the ladder sections 11 of the telescopically extendable/collapsible ladder 10.

While at least one uppermost ladder section 11n is fashioned with a pass-through portion 12, an unobstructed and safe user's passage through this at least one (for instance the uppermost) ladder section 11n is enabling to the user to go from or onto the ladder 10 when it is required without the risky maneuver described above.

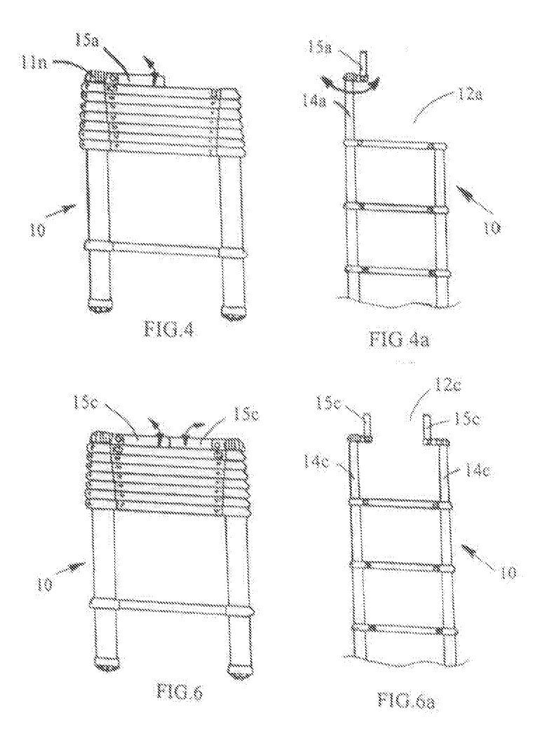

The pass-through portion 12a of the at least one uppermost ladder section 11n (see FIGS. 4 and 4a) could be fashioned by at least one autonomous element 14a, telescopically inserted into a ladder section located below. This permits the unobstructed and safe passage of the user through this at least one uppermost ladder section 11n. The autonomous element 14 could be fashioned as a part of the ladder section as well.

The pass-through portion 12b of the at least one uppermost ladder section 11n could be fashioned by two autonomous elements 14b (see FIG. 5, 5a and 5b) telescopically inserted into a ladder section 11n-1 located below, with a possibility to be extended/collapsed and locked/unlocked, while the autonomous elements 14b configure the pass-through portion 12b, to allow unobstructed and safe passage of the user through this at least one uppermost ladder section 11n. The autonomous elements could be locked/unlocked on mutually equal or not levels.

The autonomous element(s) 14 could be inserted into the ladder section located below with a possibility to be rotated (indicated as arrow on FIGS. 3a and 4a) into a necessary position relative to the ladder 10 surface, and to be locked in this position after the rotation. The autonomous element 14 could be inserted into another ladder section 11 (typically the one located below) with a possibility to be rotated into the necessary position relative to the ladder surface, and could be locked in the necessary, equal or not, angular position after rotation. When an upper part of the autonomous element is angularly oriented to the ladder surface, the method creates a hooking-effect to further secure the telescopically extendable/collapsible ladder in preferable position.

There also exist an option of the autonomous element 14 to be telescopic (not shown) with a possibility to be extended or contracted.

With reference to FIGS. 4 and 6 to 10, at least one associate means 15 is joined to at least one autonomous element (like an example on FIG. 4, it is indicated as 14a) of the at least one ladder section for cooperation with a possibility to liberate the pass-through portion 12 of the at least one ladder section, (for illustration, the uppermost ladder section 11n) for an unobstructed and safe passage of the user through this section. When it is necessary, the pass-through portion 12 could be at least partially obstructed by the associate means 15. It is obvious for those of ordinary skill into the art that the associate means 15 could be telescopic (not shown) and could be extended or contracted.

Another embodiment of the invention is shown on FIGS. 5 to 10, where at least one (often, the uppermost) ladder section is fashioned by two autonomous elements 14b, 14c, 14d or 14e telescopically inserted into a ladder section located below. The autonomous elements 14 are protruding from a ladder section located below, with a possibility to be extended/collapsed and locked/unlocked on the equal or not equal level. This forms the pass-through portion 12 allowing an unobstructed and safe passage 12 between them without obstacles. The autonomous elements 14 may well be gripped by the user for self-sustaining.

At least one associate means 15 is joined to at least one of the autonomous elements 14 of at least one ladder section 11n for cooperation with a possibility to liberate the pass-through portion 12 of the at least one ladder section 11n for an unobstructed and safe passage through this section, or to obstruct this pass-through portion 12.

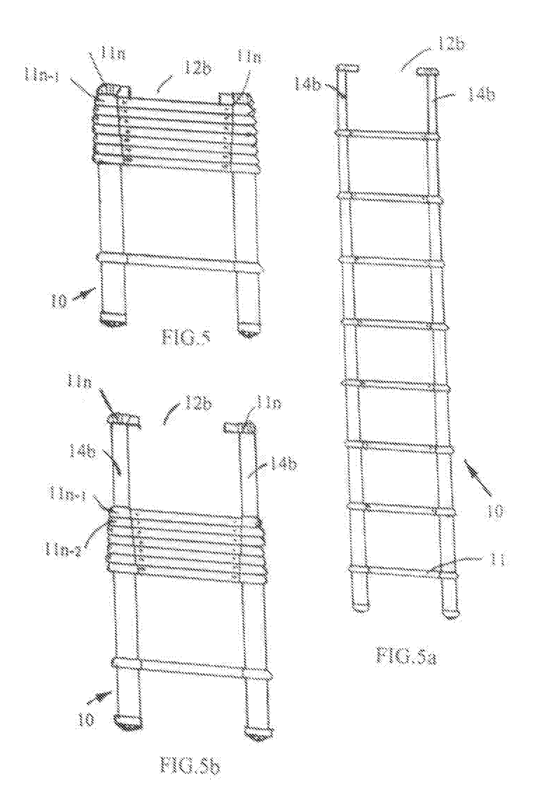

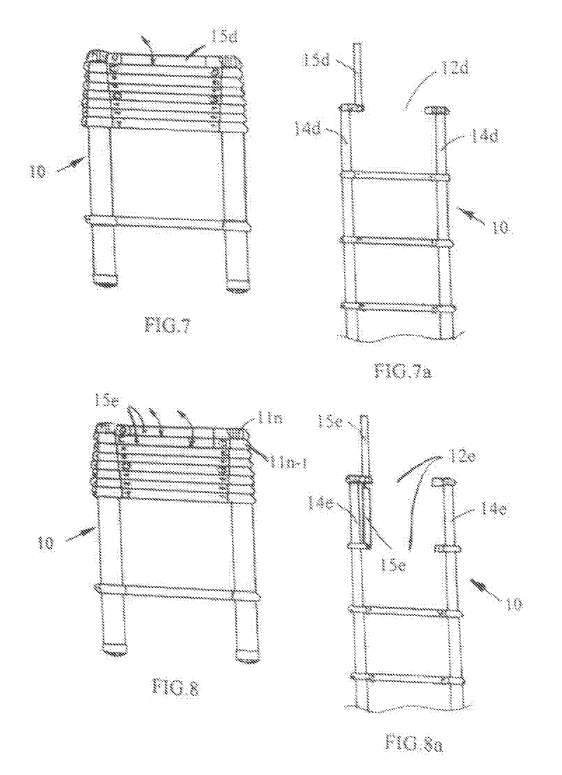

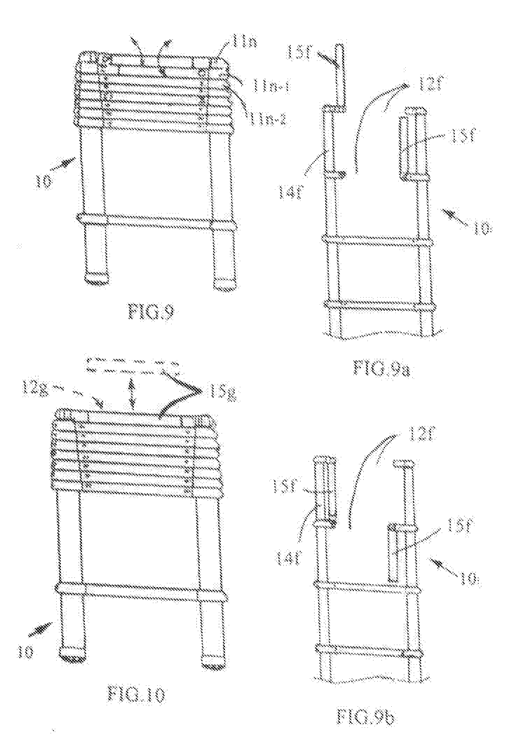

FIGS. 6 to 10 show different possibilities of cooperation between the associate means 15 and the autonomous element(s) 14 of at least one (FIGS. 6 and 7) or two (FIGS. 8 and 9) ladder section 11n and/or section 11n-1. This mutual cooperation could include, but not limited to different forms, for instant, connecting/disconnecting (FIG. 10), securing, etc, with a possibility to be pivoting up (FIGS. 4a, 6a, 7a, 8a and 9a) and/or down (FIG. 9b). Any other form of cooperation, obvious for those of ordinary skill in the art, could be in use.

Referring to FIGS. 2 to 10, the present invention describes a method to fashion and use a telescopically extendable/collapsible ladder 10 that allows an unobstructed and safe passage of the user through at least one ladder section, which could be at least one of the ladder section located on an upper part of this telescopically extendable/collapsible ladder 10. The ladder 10 is composed of a several ladder sections 11. Each of the ladder section 11 are telescopically inserted into a ladder section located below, and can be extended/collapsed and locked/unlocked to form this telescopically extendable/collapsible ladder 10, designed to be set into extended or collapsed mode, as needed.

The method comprises the steps of fashioning at least one ladder section 11 with a pass-through portion 12; extending the telescopically extendable/collapsible ladder 10 into required mode into a needed level; and providing an unobstructed passage through the pass-through portion 12 of the at least one ladder section 11 of the telescopically extendable/collapsible ladder 10.

In the case when the at least one ladder section 11 is at least one uppermost ladder section 11n, the method comprises the steps of fashioning this at least one uppermost ladder section 11 with the pass-through portion 12; extending the telescopically extendable/collapsible ladder 10 into the required mode; extending Into the required mode at least one uppermost ladder section 11n containing the pass-through portion 12, providing an unobstructed and safe passage through the pass-through portion 12 of the at least one uppermost ladder section 11n of the telescopically extendable/collapsible ladder 10.

The method, according to present invention, includes a possibility to make the pass-through portion 12 as a saw cut in at least one ladder section. For instance, it could be the ladder section 11n-x.

The pass-through portion 12 of at least one uppermost ladder section 11n could be fashioned by at least one autonomous element 14, which is telescopically inserted into a ladder section 11n-1 located below, and can be extended/collapsed and locked/unlocked. When the autonomous element 14 is telescopic, the method includes the possibility to arrange the element 14 in the required mode.

The method further comprise the step of joining at least one associate means 15 to at least one autonomous element 14 of the at least one (often the uppermost) ladder section 11n for cooperation with a possibility to liberate the pass-through portion 12 of the at least one ladder section 11n for an unobstructed and safe passage of the user through this section 11n, or at least partially obstruct this pass-through portion 12. When the associate means 15 is telescopic, the method includes arranging this means 15 in the required mode.

In another embodiment of the method described in the present invention, the pass-through portion 12 of at least one ladder section 11 n is fashioned by two autonomous elements 14 being telescopically inserted into a ladder section 11n-1 located below, that autonomous elements 14 can be extended/collapsed and locked/unlocked on an equal or not level.

In this case, our invention provides a possibility of an unobstructed and safe passage of the user through at least one uppermost ladder section 11n of the ladder 10. The method further comprises the step of joining at least one associate means 15 to at least one of the two autonomous elements 14 of the at least one (often the uppermost) ladder section 11n for cooperation with a possibility to liberate the pass-through portion 12 of this at least one ladder section 11n for an unobstructed and safe passage of the user through this section 11n, or to obstruct this pass-through portion 12. When the autonomous element 14 or/and the associate means 15 are telescopic, the method includes arranging them in the required mode.

The method further comprises the step of rotating and locking at least one autonomous element into the necessary position relative to the ladder surface.

According to our invention, at least one ladder section (for instance, the uppermost ladder section 11n) has a pass-through portion 12 allowing an unobstructed and safe passage through this pass-through portion 12, which becomes a very important security measure when it is necessary for the user to go from or onto the extendable/collapsible ladder 10 or to deliver a burden which at same time is weighty and off-clearance.

It is obvious for those of ordinary skill in the art, that the pass-through portion 12 according to our invention could be fashioned at one or more than one ladder section (as an example, in one embodiment it is made at the one uppermost ladder section 11n; in another embodiment when it is made at two ladder sections, which could be two consecutive sections 11n and 11n-1; or two non-consecutive sections 11n and 11n-3) of the extendable/collapsible ladder 10, depending to the ladder's application (see FIGS. 2 to 10). There is also a possibility that the pass-through portion 12 could be fashioned at more than two ladder sections.

As is shown on FIGS. 2 to 10, the pass-through portion 12 of the at least one uppermost ladder section 11n is fashioned by one or two autonomous elements 14 telescopically inserted into a ladder section 11n-1 located below, while each of the autonomous elements 14 can provide a safe passage 12 through this section 11n or/and 11n-1 without obstacles. The autonomous element(s) can also be gripped, if necessary, by the user for self-sustaining.

The above are examples of various embodiments of different variations of the pass-through portion 12 of the telescopically extendable/collapsible ladder 10, On FIGS. 2 to 10, the indications a, b, c, d, e, f and g are used to specify that they are related to 10, 11, 12, 14 and 15 in related embodiments.

For ease of illustration and as an aid to understanding, in the subsequent description of the illustrative examples, it should be emphasized in the context of the present specification that no particular definition or selection of any specific dimensions, proportions or sizes for pass-through portion 12 is required. The above are just a few illustrative examples, according to the present invention, of how the telescopically extendable/collapsible ladder 10 could be fashioned, used or defined. In other embodiments, other autonomous element(s) 14 and associated means 13 can be used to create a pass-through portion 12 on at least one ladder section 11, depending on the known characteristics of the telescopically extendable/collapsible ladder 10.

Again, it should be understood that the telescopically extendable/collapsible ladder and method to fashion and use the same set forth above is simply an illustrative embodiment of the present invention. It is not intended to define or limit the scope of the present invention.

Finally, it should be noted that, while the above-described device and method for providing an unobstructed and safe user's passage through at least one (often the uppermost) ladder section of a telescopically extendable/collapsible ladder, with the aid of pass-through portion, other appropriate modification(s) could equally benefit from this new and inventive telescopically extendable collapsible ladder and method to fashion and use the same.

Modifications and improvements to the above-described embodiments of the present

Invention may become apparent to those skilled in the art. The foregoing description is intended to be illustrative rather than limiting. The scope of the present invention is therefore intended to be limited solely by the scope of the appended claims.

1. A telescopically extendable/collapsible ladder designed to be set into needed extended or collapse mode, the ladder being composed of a several ladder sections, each of the ladder sections being telescopically inserted into a ladder section located below, with a possibility to be extended/collapsed and looked/unlocked, wherein at least one ladder section is being fashioned with a pass-through portion to provide the user with a possibility of an unobstructed passage through this at least one ladder section.

2. The ladder according to claim 1, wherein the at least one ladder section being fashioned with the pass-through portion is at least one uppermost ladder section.

3. The ladder according to claim 2, wherein the pass-through portion is a saw cut dividing the at least one ladder section onto autonomous elements.

4. The ladder according to claim 2, wherein the pass-through portion being created by at least one autonomous element, the autonomous element is telescopically inserted into the ladder section located below, with a possibility to be extended/collapsed and locked/unlocked.

5. The ladder according to claim 4, wherein the autonomous element is telescopic.

6. The ladder according to claim 5, further comprising at least one associate means being adjustably joined to the at least one autonomous element of the at least one ladder section for cooperation with a possibility to liberate or to obstruct the pass-through portion.

7. The ladder according'to claim 6, wherein the associate means is telescopic.

8. The ladder according to claim 2, wherein the pass-through portion is created by two autonomous elements, the autonomous elements are telescopically inserted into the ladder section located below, with a possibility to be extended/collapsed and locked/unlocked on an equal or not level.

9. The ladder according to claim 8, wherein at least one autonomous element is telescopic.

10. The ladder according to claim 9, further comprising at least one associate means being adjustably joined to at least one of the autonomous elements of the at least one ladder section for cooperation allowing a possibility to liberate or to obstruct the pass-through portion.

11. The ladder according to claim 10, wherein at least one associate means is telescopic.

12. The ladder according to claim 11, wherein the autonomous elements are telescopically inserted into the ladder section located below with a possibility to be rotated and locked relative to the ladder surface into an equal or not angular position.

13. A method to fashion and use a telescopically extendable/collapsible ladder designed to be set into extended or collapsed mode as needed, the ladder being composed of several ladder sections, each of the ladder sections being telescopically inserted into a ladder section located below with a possibility to be extended/collapsed and locked/unlocked, the method comprising the steps of:
fashioning at least one ladder section with a pass-through portion;
extending the telescopically extendable/collapsible ladder into a needed level; and
providing an unobstructed passage through the pass-through portion of the at least one ladder section of the telescopically extendable/collapsible ladder.

14. The method according to claim 13, wherein the at least one ladder section is at least one uppermost ladder section, comprising the steps of:
fashioning the at least one uppermost ladder section with the pass-through portion;
at least partially extending the telescopically extendable/collapsible ladder to set in into the needed level;
extending the at least one uppermost ladder section containing the pass-through portion into the needed level; and
providing an unobstructed passage through the pass-through portion of the at least one uppermost ladder section of the telescopically extendable/collapsible ladder.

15. The method according to claim 14, wherein the pass-through portion is made as a saw cut dividing the at least one ladder section onto autonomous elements.

16. The method according to claim 14, wherein the pass-through portion of at least one ladder section is being fashioned by at least one autonomous element being telescopically inserted into a ladder section located below, with a possibility to be extended/collapsed and locked/unlocked.

17. The method according to claim 16, further comprising the step of:
joining at least one associate means to at least one autonomous element of the at least one ladder section for cooperation with a possibility to liberate the pass-through portion of the at least one ladder section for an unobstructed and safe passage of the user through this section, or to obstruct this pass-through portion.

18. The method according to claim 17, wherein the pass-through portion of at least one ladder section is being fashioned by two autonomous elements, the autonomous elements are telescopically inserted into a ladder section located below, with a possibility to be extended/collapsed and locked/unlocked on an equal or not level.

19. The method according to claim 18, further comprising the step of;
joining at least one associated means to at least one of two autonomous elements of the at least one ladder section for cooperation with a possibility to liberate the pass-through portion of the at least one ladder section for an unobstructed and safe passage of the user through this section, or to obstruct this pass-through portion.

20. The method according to claim 19, further comprising the steps of:
rotating at least one autonomous element into a necessary position relative to the ladder surface; and
locking the autonomous element into a necessary position relative to the ladder surface.
